(19) United States
(12) Patent Application Publication
(10) Pub. No.: US 2009/0321474 A1
(43) Pub. Date: Dec. 31, 2009

(54) DISPENSER HAVING AUDIO FUNCTIONALITY

(75) Inventors: Shean R. Ferrell, Chaska, MN (US); Eric J. Voltin, Medina, MN (US); Joseph A. Pellegrene, Minnetonka, MN (US); Wong Chi Yip, Tseung Kwan O (HK)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: PELLEGRENE FERRELL ASSOCIATES, Medina, MN (US)

(21) Appl. No.: 12/163,204

(22) Filed: Jun. 27, 2008

(51) Int. Cl. B67D 5/42; B67D 1/07

(52) U.S. Cl. 222/39; 222/192

(57) ABSTRACT

Systems and methods concerned with design advancements with respect to the dispenser technical art. Some of these design advancements have led to increased water shedding effectiveness, minimization of dispensing head size, and higher quality resonance from the dispenser.

### BACKGROUND

Dispensers used with soap, e.g., generally in a liquid or semi-liquid form, are well known in the art. Compared with using solid soap bars for cleansing/sanitizing activities, the use of liquid soap dispensers offers a variety of advantages. For example, because only a certain amount of liquid soap is distributed per user activation of the dispenser, the remainder of the soap is kept within the dispenser, thereby being protected from the spread of germs between subsequent users. Additionally, because only a small amount of the entire amount of liquid soap is handled during any cleansing activity, there is generally less soapy mess left over from such activity (as opposed to a user handling an entire solid bar soap during such activity). Finally, with the dispensers allowing for a large amount of liquid soap to be stored (as compared to a single solid soap bar), the whole of the liquid soap can be generally found to last longer, with soap replacement being less frequent.

Generally, liquid soap dispenser assemblies include a dispensing head that works in conjunction with a reservoir that holds the liquid soap. In some cases, when the assembly is designed with the dispensing head below the liquid soap reservoir, a simple activation of the dispensing head (e.g., via a pulling/pushing of the dispensing head) can result in an opening being temporarily provided to the reservoir. In such cases, the liquid soap can be briefly enabled to pass from the reservoir to the dispensing head via the opening, whereupon the liquid soap passing through the opening flows freely out of the dispensing head. In some cases, the design may further include a pump assembly. For example, such pump assembly can be found in designs in which the dispensing head is located above the liquid soap reservoir, where the pump assembly may include a flexible tube and a pump. Accordingly, when the dispensing head is activated (e.g., via a pushing of the head in a conventional way), the pump is engaged to draw liquid soap through the tube, through the dispensing head, and eventually into a user's hand.

While the primary purpose of using either solid or liquid soap is to cleanse or sanitize, the amount of soap used is often variable. As described above, a liquid soap dispenser can be used to limit the amount of soap used as the dispenser is generally configured to release a set amount of soap per activation of the dispensing head. Accordingly, excessive soap amounts are generally prevented from being used during cleansing. Another variable with respect to using soap, either solid or liquid, is the amount of time one spends in lathering the soap and spreading the lathered soap, e.g., over one's hands and/or face, for effective cleansing.

As should be appreciated, the amount of time needed to cleanse something generally depends on the size of that which is being cleansed. For example, in the case where one's hands and/or face are being cleansed, one minute may be considered a sufficient amount of time for such activity. One manner by which the dispenser may keep track of such time duration for the user is through the use of a timing circuit. In one known exemplary design, upon activation of the dispensing head, an initial beep may be sounded from an electrical circuit of the dispenser, signaling a start to the cleansing cycle, e.g., lathering and cleansing using the soap provided from the dispenser. In turn, the electrical circuit, e.g., via a timer, initiates a counter with respect to a set time period, e.g., one minute. Once the set time period is counted, i.e., elapses, the circuit can be configured to induce a second beep, signaling both an end to the time period and an end to the cleansing cycle.

As can be appreciated, such beeping from an electrical circuit in signaling start and end times with respect to a cleansing cycle can be rather mundane. Further, to better hold people's attention during a cleansing cycle, especially the attention of children, it has generally been found to be more effective to provide continuous auditory stimulation during the entire cleansing cycle. To that end, liquid soap dispensers have been designed to play music following the activation of the dispenser. Accordingly, once the dispensing head is activated, circuitry can be provided that along with a speaker or other transducer plays a song or song segment. The continuous auditory stimulation may signal that hand washing should continue. The end of the song or song segment may also signal that hand washing may be stopped.

While musical dispensers, as exemplified above, are known, there are various manners in which such designs can be further advanced. Embodiments of the present invention are focused on addressing such advancements.

### SUMMARY

Certain embodiments of the invention provide systems and methods concerned with design advancements with respect to the dispenser technical art. Some of these design advancements have led to increased water shedding effectiveness, minimization of dispensing head size, and higher quality resonance from the dispenser.

These and various other features and advantages will be apparent from a reading of the following detailed description.

### BRIEF DESCRIPTION OF THE DRAWINGS

FIG. 1 illustrates an elevation perspective view of a dispenser in accordance with certain embodiments of the invention.

FIG. 2 is an exploded side perspective view of a dispensing head of the dispenser of FIG. 1 in accordance with certain embodiments of the invention.

FIG. 3 is a top perspective view of a base of the dispensing head of FIG. 2.

FIG. 4 is a top plane view of a button of the dispensing head of FIG. 2.

FIG. 5 is a bottom plane view of a cover of the dispensing head of FIG. 2.

FIGS. 6A and 6B are elevation and top perspective views of an electrical circuit assembly used in the dispenser of FIG. 1 in accordance with certain embodiments of the invention.

FIG. 7 is a cross sectional view of the dispensing head of FIG. 1 along the lines VII-VII.

### DETAILED DESCRIPTION OF THE PREFERRED EMBODIMENTS

The following detailed description should be read with reference to the drawings, in which like elements in different drawings are numbered identically. Embodiments shown in the drawings are not necessarily to scale, unless otherwise noted. It will be understood that embodiments shown in the drawings and described herein are merely for illustrative purposes and are not intended to limit the invention to any embodiment. On the contrary, it is intended to cover alternatives, modifications, and equivalents as may be included within the scope of the invention as defined by the appended claims. For example, while embodiments described herein involve dispensers for liquid soap, the embodiments could just as well be applied to any dispenser that provides material stored therein upon activation of the dispenser by a user.

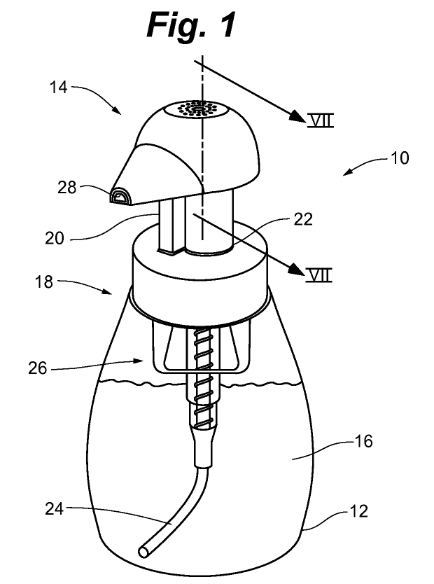

FIG. 1 illustrates a perspective view of a dispenser in accordance with certain embodiments of the invention. As shown, in such embodiments, the dispenser 10 can be a liquid soap dispenser. The dispenser 10 generally includes a reservoir 12 and a dispensing head 14. As shown, the reservoir 12 contains the liquid soap 16, while the dispensing head 14 facilitates the transport of the soap 16 from the reservoir 12, and eventually, outside the dispenser 10.

In certain embodiments, as described above, the dispensing head 14 includes a pump assembly 18. The pump assembly 18 is operatively coupled to the dispensing head 14 and works in conjunction with the liquid soap reservoir 12. As shown, in certain embodiments, a neck 20 of the dispensing head 14 can be inserted in a recess 22 of the pump assembly 18. While not visibly shown, by way of such coupling, tubing from each of the dispensing head neck 20 and the pump assembly 18 can be simultaneously connected. The pump assembly 18 can be further operatively coupled to the reservoir 12. For example, while not visibly shown, a neck of the pump assembly 18 may be threadably engageable with a neck of the reservoir 12.

With further reference to FIG. 1, the pump assembly 18 includes a flexible tube 24 that extends into the liquid soap reservoir 12 in a well known manner. In certain embodiments, the pump assembly 18 includes a pump 26 that, in certain embodiments, extends from the pump assembly 18 and operates with the flexible tube 24. In certain embodiments, when the dispensing head 14 is activated, e.g., pushed down, the pump 26 is engaged to draw the liquid soap 16 up through the tube 24, through the dispensing head 14, and eventually into a user's hands. In certain embodiments, upon activation of the dispensing head 14, the pump 26 is further configured to pull air from the surrounding environment into the liquid soap 16 that is drawn up through the tube 24. In turn, the pulled-in air mixes with the soap 16 to form foam, which is subsequently output from the dispensing head 14.

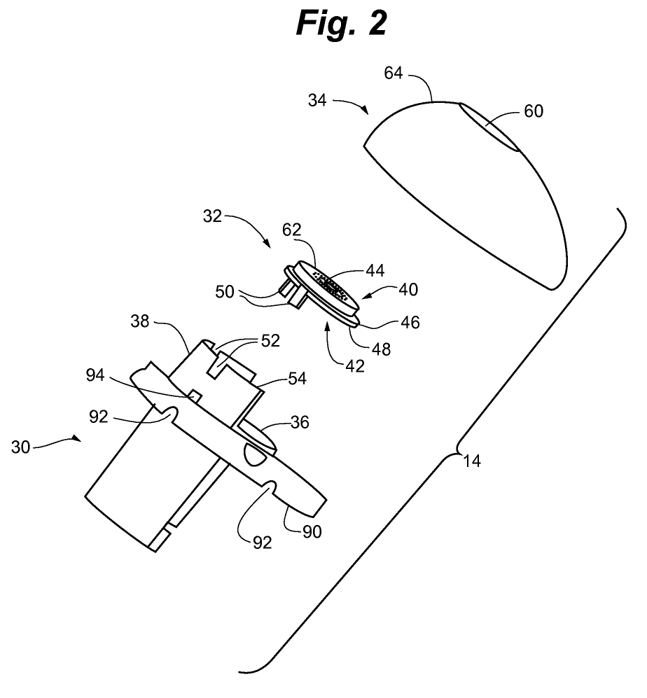

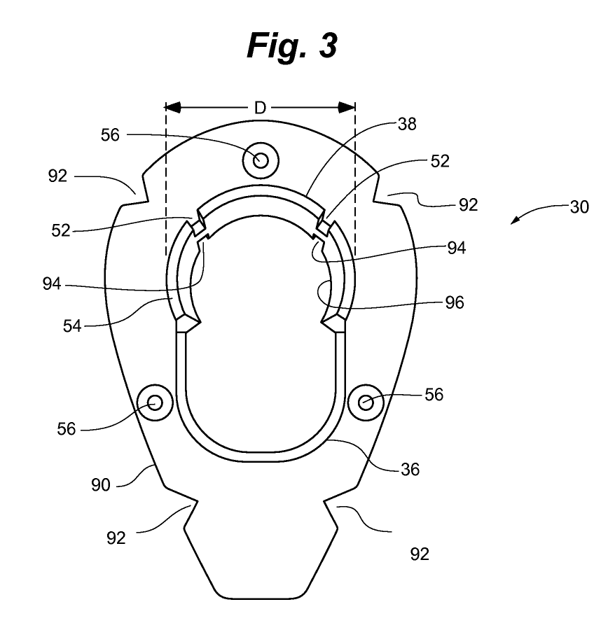

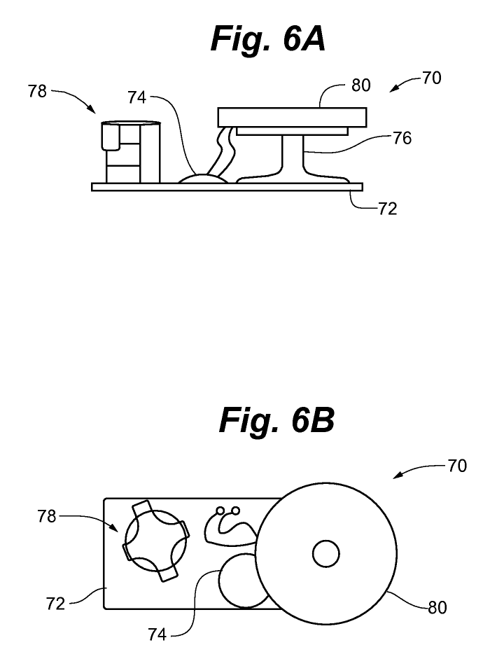

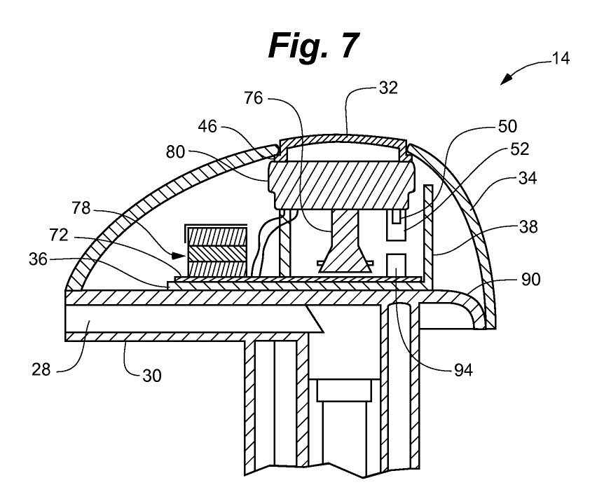

FIG. 2 shows an exploded view of the dispensing head 14 in accordance with certain embodiments of the invention. The head 14 includes a base 30, a button 32, and a cover 34. When the head 14 is assembled, the button 32 and cover 34 are each positioned above the base 30. In certain embodiments, as shown in FIGS. 2 and 3, the base 30 includes a platform 36 with a chamber 38 generally extending from the platform 36. The platform 36 and chamber 38 are collectively used to support an electrical circuit (not shown) of the dispenser 10, which is shown and further described herein with reference to FIGS. 6A and 6B. In certain embodiments, the chamber 38 is formed to be generally circular; however, the invention should not be so limited.

The button 32 is configured to facilitate triggering of the electrical circuit of the dispenser 10, with such triggering caused by the button 32 being activated, e.g., pressed downward. In certain embodiments, such activation of the button 32 can be performed separate from an activation of the dispensing head 14 (e.g., via depression of button 32 without depression of the entire dispensing head 14). As such, the circuit can be triggered solely without also requiring soap to be dispensed. However, it should be appreciated that both the dispensing head 12 and button 32 can be both simultaneously activated with a single action, e.g., simultaneous depression of both the dispensing head 14 and the button 32.

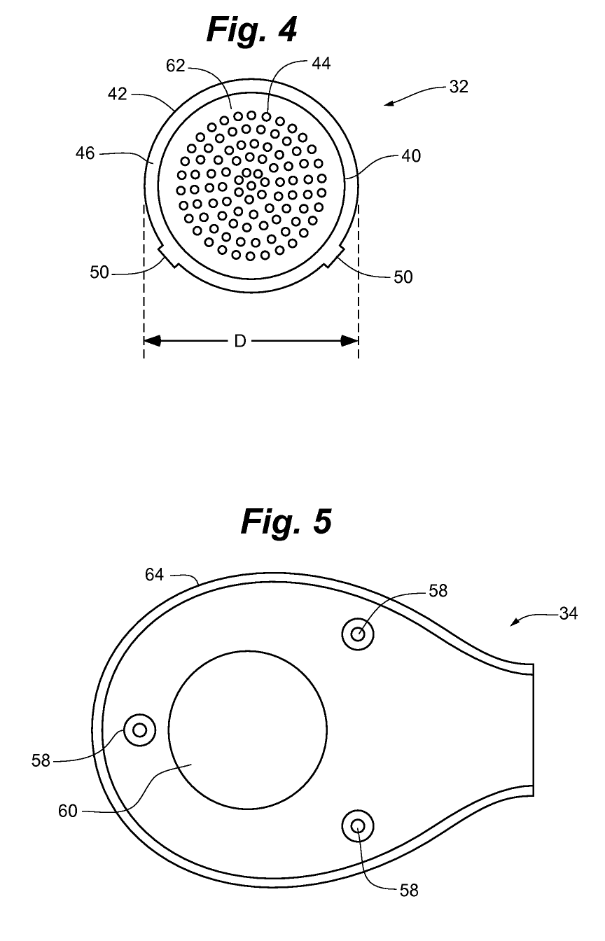

With reference to FIGS. 2 and 4, the button 32 has an inner portion 40 and an outer portion 42. In certain embodiments, the inner portion 40 is defined with a plurality of holes 44 there through, and the outer portion 42 forms a shelf 46 for the button 32. When in a non-activated state, i.e., not depressed, the button 32 is suspended above the chamber 38. In certain embodiments, as further detailed herein with respect to FIGS. 6 and 7, such suspension of the button 32 is provided by one or more electrical components of the electrical circuit being in continuous contact with a lower surface 48 of the button shelf 46. In certain embodiments, with further reference to FIG. 7, when the button 32 is activated, e.g., depressed, the lower surface 48 of the button shelf 46 results in a force, e.g., a downward force, on one or more electrical components of the electrical circuit, thereby triggering the circuit.

In assembling the dispensing head 14, the button 32 is positioned above the chamber 38. In certain embodiments, the button 32 and the chamber 38 have substantially similar outer diameters D. Having such similar outer diameters D enables the chamber 38 to generally mate with the button outer portion 42. In certain embodiments, such mating of the button outer portion 42 with the chamber 38 is facilitated via tabs 50 stemming from the button 32, where the tabs 50 extend from the button outer portion 42 toward respective slots 52 defined by the chamber 38. In certain embodiments, each slot 52 is defined from an upper surface 54 of the chamber 38 and is sized to mate with the corresponding tabs 50 of the button 32. As shown, the tabs 50 are similar in size; however, the invention should not be limited to such, as the tabs 50 can be formed in any combination of differing sizes so long as the corresponding slots 52 are defined to mate therewith. While two tabs 50 are shown protruding from the button 32, with two corresponding slots 52 defined in the chamber 38, the invention should not be limited to such quantities. Tabs 50 and slots 52 may cooperate to prevent the button from rotating relative to the base 30 yet tabs 50 are relatively short enough to allow axial movement (relative to the pump head 14) downward further into slots 52 when the button 32 is depressed.

As described above, when in its non-activated state, the button 32 is suspended above the chamber 38. Accordingly, when the button 32 is in its non-activated state, the tabs 50 are aligned with the corresponding slots 52, yet not fully inserted therein. In certain embodiments, upon activation of the button 32, the tabs 50 are, in turn, lowered into their corresponding slots 52 of the chamber 38. Such mating of the tabs 50 to the slots 52 achieves general alignment of the button 32 with respect to the chamber 38, and in turn, the electrical components thereon. As such, in certain embodiments, upon activation of the button 32, the lower surface 48 of the button shelf 46 subjects a force, e.g., a downward force, on one or more electrical components of the electrical circuit, and thereby triggers the circuit.

In further assembling the dispensing head 14, the cover 34 is placed over both the base 30 and the button 32, with the cover 34 being fastened to the base 30 using a plurality of fasteners (not shown). With reference to FIG. 3, in certain embodiments, the base 30 is defined with a plurality of apertures 56, with each aperture 56 being aligned with a corresponding boss 58 defined in the underside of the cover 34 (shown in FIG. 5) when the cover 34 is positioned over the base 30. Accordingly, when the cover 34 is secured to the base 30, the fasteners are each inserted into one of the apertures 56 and further secured to the respective bosses 58 of the cover 34.

With reference to FIGS. 2 and 5, the cover 34 further includes an opening 60 sized to mate with the button inner portion 40. In certain embodiments, the opening 60 is sized to allow penetration of the button inner portion 40 yet deny penetration of the button outer portion 42. Consequently, when the button 32 is suspended above the chamber 36 in its non-activated state (as described above), the button outer portion 42 contacts the inner surface of the cover 34, thereby limiting the extent by which the button inner portion 40 passes through the opening 60. In certain embodiments, the button inner portion 40 is allowed to penetrate the opening 60 to an extent whereby an upper surface 62 of the inner portion 40 is aligned with, or slightly protruding above, an outer surface 64 of the cover 34.

As described above, the platform 36 and chamber 38 of the base 30 are collectively used to support an electrical circuit of the dispenser 10. Such electrical circuit 70 is exemplarily shown in FIGS. 6A and 6B in accordance with certain embodiments of the invention. FIG. 6A illustrates an elevation view of the electrical circuit 70, while FIG. 6B illustrates a top view of the circuit 70. The electrical circuit 70, in certain embodiments, includes a circuit board 72 having a microchip 74, a momentary switch 76 operatively coupled to the microchip 74, and a power source 78, e.g., in the form of one or more batteries, to power the microchip 74. Also provided and electrically connected to the circuit board 72 is a speaker 80.

The electrical circuit 70, when triggered, is designed to provide an audible response. In certain embodiments, such audible response involves playing music. In certain embodiments, the played music involves a recorded song being played. As described above, liquid soap dispensers have been designed to play music for a set period of time when activated, with the set period of time representing the requisite time for a cleansing activity, e.g., cleansing one's hands and/or face. However, embodiments of the invention should not be limited to such. Instead, the song played by the electrical circuit 70 can be geared to solely entertain the user during cleansing regardless of how long the cleansing lasts. As such, the played song may last longer than a cleansing cycle, or conversely, may stop before a cleansing cycle is finished. As described above, the electrical circuit 70 can be triggered via an activation of the button 32, and such activation can be performed separate from any activation of the dispensing head 14. Consequently, if the played song stops before the user finishes his cleansing activity, the user can trigger the electrical circuit one or more further times so as to play the music one or more further times without having further soap dispensed from the dispensing head 14.

As described above, the electrical circuit 70, when triggered, is designed to provide an audible response, which, in certain embodiments, can involve playing music. Alternatively, in certain embodiments, the auditory response can involve playing a message. For example, in certain embodiments, the message can involve instructions or directions played for a consumer who has purchased the dispenser or is interested in purchasing the dispenser. As such, the instructions or directions, for example, can be used to aid the consumer in using the material in the dispenser and/or in using the dispenser. Optionally, the instructions/directions may also include best practices and/or benefits that can be achieved in using the material in the dispenser and/or in using the dispenser. In certain embodiments, the message can involve promotional information for one or more of the material in the dispenser, the dispenser, or other products. As should be appreciated, in embodiments in which the dispenser plays a message, the message can involve a seemingly endless variety of information to the end consumer. Accordingly, while the above provides a few examples of what the message may be, the invention should not be limited to such. Further, in certain embodiments, the triggering of the electrical circuit 70 can trigger, in any combination, both music and a message being played.

In certain embodiments, the electrical circuit 70 is triggered with a downward force on the momentary switch 76. As shown, the switch 76 is located on the circuit board 72 below, but in contact with, the speaker 80. The speaker 80 is a solid structure, while the momentary switch 76 is largely formed of a flexible material, e.g., rubber. Accordingly, in certain embodiments, a downward force on the speaker 80 is subsequently transferred to the switch 76. Upon absorbing a downward force, the momentary switch 76 is depressed and is operatively connected to the microchip 74. In certain embodiments, the contact of the momentary switch 76 is normally suspended above the circuit board 72, upon which the microchip 74 is located. Consequently, in certain embodiments, only through the momentary switch 76 absorbing a downward force can the microchip 74 be activated, thereby triggering the electrical circuit 70.

Following its activation from the momentary switch 76, the microchip 74 facilitates providing an audible response from the dispenser 10. As described above, in certain embodiments, the audible response can involve playing of music. In such embodiments, the played music can involve a recorded song being played. In certain embodiments, the recorded song is a WAVE file (short for waveform audio format, which is an audio file format standard for storing an audio bitstream on PCs) that is transcoded into a file format known as ADPCM (Adaptive Differential Pulse Code Modulation) and compressed onto the microchip 74. Activating the microchip 74 causes the ADPCM file stored in the microchip 74 to be transmitted in the form of electrical signals to the speaker 80. In certain embodiments, the ADPCM file will play for duration of time dependent on the size of the file and then stops. In certain embodiments, when the ADPCM file finishes playing, the user knows he has washed his hands sufficiently. In certain embodiments, several songs are stored in the microchip 74. In one such embodiment, each time the circuit 70 is activated, a different one of such stored songs is selected and played.

As described above, in certain embodiments, the audible response provided by the dispenser 10 via the microchip 74 can involving providing a message. In certain embodiments, the message provided can involve a recorded message being provided. Similar to that described above with reference to the auditory response involving a recoded song being played, the recorded message, in certain embodiments, can be a WAVE file that is transcoded into an ADPCM file format and compressed onto the microchip 74. Activating the microchip 74 causes the ADPCM file stored in the microchip 74 to be transmitted in the form of electrical signals to the speaker 80. In certain embodiments, the ADPCM file will play for duration of time dependent on the size of the file and then stops. In certain embodiments, several messages are stored in the microchip 74. In one such embodiment, each time the circuit 70 is activated, a different one of such stored messages is selected and played.

In certain embodiments, an on/off switch can be added to the electrical circuit 70. Such switch can be located on the outer surface of the dispensing head 14 and electrically connected to the circuit board. In certain embodiments, the switch is located on the outer surface 64 of the cover 34, generally opposite the soap dispensing port 28 of the dispensing head 14. As should be appreciated, the on/off switch can be any of a number of switch types. For example, in certain embodiments, the switch can be a master switch, whereby it must be “on” for the momentary switch 76 to function as described above. In particular, if the master switch is turned “off”, any music playing via the electrical circuit 70 would be immediately halted. In other embodiments, the switch could be wired as an OR switch. In turn, either one of the on/off switch or the momentary switch 76 could be used to trigger the electrical circuit 70, while neither of the switches solely would be able to halt the music mid-stream.

In certain embodiments, a volume control may be added to the electrical circuit 70. An actuator for the volume control can be located on the outer surface of the dispensing head. In certain embodiments, the volume actuator is located on the outer surface 64 of the cover 34, generally opposite the soap dispensing port 28 of the dispensing head 14. As should be appreciated, the actuator for the volume control can be any of a number of actuator types, including a thumb dial, a slide switch, and other forms well known in the art.

FIG. 7 illustrates a cross section of the dispensing head 14 of FIG. 1. As shown, the electrical circuit 70 of FIG. 6 is provided within the dispensing head 14 of the dispenser 10. The cross section shows the button 32 of the dispensing head 14 in a non-activated state. As such, there is no contact between the momentary switch 76 and the circuit board 72. Consequently, the microchip 74 is not activated, leaving the electrical circuit 70 in a non-triggered state.

As already described above with reference to FIGS. 2-5, upon the button 32 being activated, e.g., depressed, the force placed on the button 32 is transferred to the momentary switch 76, resulting in contact between the switch 76 and the circuit board 72 and simultaneous activation of the microchip 74. As further described above, such activation of the microchip 74 results in music and/or a message being played over the speaker 80 of the electrical circuit.

In light of the above embodiments, a number of design advancements are provided for the musical dispenser technical art. One such advancement involves the increased effectiveness of the dispensing head 14 to shed water. As is customary, in the course of washing one's hands at a sink, a person will often run water over his hands prior to lathering them with soap. In using a soap dispenser to provide the soap in this scenario, it is often the case that the person will drip water from his hands on the dispensing head of the dispenser. Dispensing heads of musical dispensers are generally formed of a plurality of parts. For example, in reference to FIG. 2, such dispensing head 14 includes three primary parts: a base 30, a button 32, and a cover 34. It should be appreciated that water dripping on the dispensing head 14 can flow therein, e.g., between the button 32 and the cover 34, through the holes 46 of the button, etc. The entry of water into the dispensing head can lead to a variety of adverse effects on the functionality of the dispenser, most notably with respect to prolonged contact with any electrical components housed in the dispensing head.

With reference to FIG. 2, 3, and 7, the dispensing head 14 offers a variety of designs to effectively shed water from its head 14. For example, in certain embodiments, the base 32 of the dispensing head 14 has one or more of outer edges 90 curving downward. Accordingly, such downward curvature of the edges 90 urges water collecting in the dispensing head 14 to flow toward these edges 90, subsequently exiting the head 14 by flowing between these edges 90 and the bordering edges of the cover 34. As such, water entering the dispensing head 14 naturally flows toward the edges 90, urging water to exit the head 14 quickly and effectively. While all the base outer edges 90 are shown with such curvature, the invention should not be limited to such. Any number of outer edges 90 of a dispensing head base 30 can be formed to have such downward curvature. However, it should be appreciated that providing each base outer edge 90 with such downward curvature maximizes the water shedding effectiveness of the dispensing head 14.

In certain embodiments, with continued reference to FIGS. 2 and 3, one or more notches 92 are provided in the outer edges 90 of the base 30. Such design further urges the quick exit of water collecting in the dispensing head 14. As described above, while the downward curvature of the base outer edges 90 urges collecting water to flow thereto, the water still must pass between these edges 90 and the bordering edges of the cover 34 to exit the head 14. However, if the cover 34 is tightly secured to the base 30 in such area, the water may not be able to freely exit the head 14. Accordingly, by providing one or more notches 92 in the base outer edges 90, one or more certain exit points are correspondingly facilitated. With reference to FIG. 3, in certain embodiments, a plurality of outer edge notches 92 are provided so as to form a uniform pattern of notches 92 around the base 30. As such, entering water is prevented from collecting along the perimeter of the base 30. To the extent some water or other liquid does gather, components on the circuit board may be potted and the batteries may be enclosed or overmolded with insulators to help prevent electrical shorting of the components.

In certain embodiments, with further reference to FIGS. 2, 3, and 7, one or more slots 94 are further cut in the chamber 38 of the base 30. While the chamber 38 facilitates a sturdy surrounding for aligning the speaker 80 with the button 32 and vice versa, the chamber 38 allows for an area on the base in which entering water may collect. Accordingly, by providing one or more slots 94 in the chamber 38, one or more certain exit points are correspondingly facilitated. As shown, each slot 94 is defined from an inner lower edge 96 of the chamber 38. With reference to FIG. 3, in certain embodiments, a plurality of slots 92 are provided so as to form a uniform pattern of slots 92 around the chamber 38. As such, slots 92 facilitate drainage of water entering chamber 38, thereby preventing pooling of water along the inner lower edge 96 of the chamber 38.

A further advancement for the musical dispenser technical art provided by the above embodiments involves a compactness of the electrical circuit 70 within the dispensing head 14. As should be appreciated, the size of the dispensing head is often adversely affected when housing electrical circuitry within the head. Such size increase in the dispensing head can lead to a variety of problems. For example, such would generally increase the material/fabrication costs associated with the dispenser. Further, a larger head size may be unappealing to customers, which in turn, could decrease market share. As such, keeping the dispensing head to a minimum size is generally desired.

With reference to FIGS. 6A and 7, the dispensing head 14 is minimized using a number of differing techniques with respect to the electrical circuit 70 housed therein. For example, one or more electrical components are stacked so as to take up less space on the circuit board 72. In certain embodiments, the speaker 80 is mounted above the momentary switch 76. The momentary switch 76, in certain embodiments, is provided directly above its contact point on the circuit board 72. In certain embodiments, the power source 78, e.g., taking the form of a plurality of batteries, involves stacked batteries. As described above, while stacked electrical components enable the use of a smaller circuit board 72, the amount of wiring between such stacked electrical components is also limited. Accordingly, the size of the electrical circuit 70 is reduced, thereby leading to a minimized size of the dispensing head 14.

In certain embodiments, with continued reference to FIGS. 6A and 7, the speaker 80 has dual functionality in the electrical circuit 70. Not only does it serve as the output apparatus for the stored music, but it also serves as a trigger for the electrical circuit 70. To this end, the speaker 80 is located in close proximity to the circuit board 72, thereby limiting the amount of wiring between the circuit board 72 and the speaker 80. Accordingly, the size of the electrical circuit 70 is reduced, thereby leading to a minimized size of the dispensing head 14.

In certain embodiments, with further reference to FIGS. 6A and 7, the button 32 has dual functionality in the electrical circuit 70. Not only does it serve as the actuator for the electrical circuit 70, but it also serves as the sound port for the dispensing head 14. This feature is somewhat similar to that described above with the dual functionality of the speaker 80; however, the size of the electrical circuit 70 is directly affected by the proximity of both its actuator and the sound port, requiring direct contact with each. As a result, by having the button 32 serves both functions, the electrical circuit 70 can again be concentrated in this single area within the dispensing head 14. Accordingly, the size of the electrical circuit 70 is reduced, thereby leading to a minimized size of the dispensing head 14.

Yet a further advancement for the musical dispenser technical art provided by the above embodiments involves a higher quality resonance from the dispenser 10. In certain embodiments, with reference to FIG. 7, the speaker 80 enables the suspension of the sound port, i.e., the button 32, of the dispensing head 14. Accordingly, the speaker 80 is always in contact with the sound port, enabling sound from the speaker 80 to resonate through the holes 44 of the sound port. In some such embodiments, cover 34 is formed of an elastomeric material, such as plastic. Cover 34 and the button 32 combine to form a speaker grill and housing that accentuate the sound produced by the speaker 80. Holes 44 in the button 32 enable the button 32 to be a sound port for the speaker 80 following activation of the button 32.

In certain embodiments, with reference to FIG. 7, the sound port, i.e., the button 32, is retained between the opening 60 of the cover 34 and the speaker 80. In conjunction with the suspending effect provided by the speaker 80, the close fit of the button 32 with respect to the cover 34 further eliminates any gap being formed between the speaker 80 and the sound port.

Although the present invention has been described with reference to certain disclosed embodiments, those skilled in the art will recognize that changes may be made in form and detail without departing from the spirit and scope of the invention. For example, the dispenser may dispense products other than liquid soap. Dispenser need not be free-standing, such as dispenser 10. Instead, the dispenser may be mountable to a wall or other surface.

What is claimed is:

1. A dispenser for providing material stored therein following activation of the dispenser, the dispenser comprising:
a reservoir containing one or more liquid or semi-liquid materials;
a dispensing head that is operatively coupled to the reservoir, the dispensing head comprising a base and a button, the base including a chamber, each of the base and the chamber including a mechanism adapted to shed water from inside the dispensing head to outside the dispensing head; and
an electrical circuit located within the dispensing head, the electrical circuit configured to provide an audible response upon activation of the button.

2. The dispenser of claim 1 wherein the one or more liquid or semi-liquid materials comprise liquid soap.

3. The dispenser of claim 1 wherein the electrical circuit comprises a plurality of electrical components, wherein the chamber aligns two or more electrical components with the button.

4. The dispenser of claim 3 wherein the two or more aligned electrical components are vertically stacked, wherein a highest stacked electrical component contacts the button.

5. The dispenser of claim 1 wherein the dispensing head and the button comprise separate bodies, wherein the button can be activated separately from the dispensing head.

6. The dispenser of claim 1 wherein the dispensing head further comprises a cover, the cover positioned over the base and the button such that outer edges of the cover overlap outer edges of the base.

7. The dispenser of claim 6 wherein the base includes two mechanisms adapted to shed water, wherein a first of the two mechanisms comprises a general downward curvature of one or more of the outer edges of the base.

8. The dispenser of claim 7 wherein a second of the two mechanisms comprises one or more notches being provided in one or more of the outer edges of the base.

9. The dispenser of claim 1 wherein the mechanism of the chamber comprises one or more slots defined by the chamber, wherein the one or more slots extend vertically in the chamber, originating from a lower edge of the chamber.

10. The dispenser of claim 1 wherein the auditory response comprises played music.

11. The dispenser of claim 10 wherein the played music is a timed audible recording, the timed audible recording being of a set time duration for one to start and complete an activity.

12. The dispenser of claim 11 wherein the act involves cleansing one's hands.

13. A dispenser for providing material stored therein following activation of the dispenser, the dispenser comprising:
a reservoir containing one or more liquid or semi-liquid materials;
a dispensing head that is operatively coupled to the reservoir, the dispensing head comprising a base and a button, the base including a vertically extending chamber, the chamber located below and in vertical alignment with the button; and
an electrical circuit located within the dispensing head, the electrical circuit configured to provide an audible response upon activation of the button, the electrical circuit comprising a plurality of electrical components, two or more of the electrical components vertically stacked and extending from the chamber toward the button, a highest stacked electrical component contacting the button.

14. The dispenser of claim 13 wherein the one or more liquid or semi-liquid materials comprise liquid soap.

15. The dispenser of claim 13 wherein the two or more vertically stacked electrical components comprise a circuit board, a switch, and a speaker.

16. The dispenser of claim 15 wherein the highest stacked electrical component comprises the speaker.

17. The dispenser of claim 13 wherein the dispensing head further comprises a cover that is positioned over the base and the button, wherein the cover includes an opening, and wherein the button penetrates the opening via contact from the speaker.

18. The dispenser of claim 13 wherein the plurality of electrical components vertically stacked and extending from the chamber comprises a majority of the electrical components of the electrical circuit.

19. The dispenser of claim 18 wherein the majority of the electrical components of the electrical circuit being vertically stacked enables the electrical circuit to comprise a compact assembly, wherein such compact assembly enables the dispensing head to be minimized in size.

20. The musical dispenser of claim 13 wherein the button has a plurality of holes there through, wherein the holes enable the button to be a sound port for the speaker following activation of the button.

21. The dispenser of claim 13 wherein the auditory response comprises played music.

22. The dispenser of claim 21 wherein the played music is a timed audible recording, the timed audible recording being of a set time duration for one to start and complete an activity.

23. The dispenser of claim 22 wherein the act involves cleansing one's hands.

24. A dispenser for providing material stored therein following activation of the dispenser, the dispenser comprising:
a reservoir containing one or more liquid or semi-liquid materials;
a dispensing head that is operatively coupled to the reservoir, the dispensing head comprising a button and a cover, the cover being positioned over the button, the cover including an opening receiving the button; and
an electrical circuit located within the dispensing head, the electrical circuit configured to provide an audible response upon activation of the button, the electrical circuit comprising a speaker and the button having a plurality of holes there through, the holes enabling the button to be a sound port for the speaker following activation of the button, and the cover being formed of an elastomeric material, whereby the cover and the button combine to form a speaker grill and housing that accentuate the sound produced by the speaker.

25. The dispenser of claim 24 wherein the one or more liquid or semi-liquid materials comprise liquid soap.

26. The dispenser of claim 24 wherein the electrical circuit comprises two or more vertically stacked electrical components including a circuit board, a switch, and a speaker.

27. The dispenser of claim 24 wherein the highest stacked electrical component comprises the speaker.

28. The dispenser of claim 24, wherein the button has an outer shelf, and wherein the opening is sized to accommodate the button yet not the button outer shelf.

29. The dispenser of claim 28 wherein the button is supported in the opening by the speaker to press the outer shelf against an inner surface of the cover to create a tight fit between the button and the cover.

30. The dispenser of claim 24 wherein the auditory response comprises played music.

31. The dispenser of claim 30 wherein the played music is a timed audible recording, the timed audible recording being of a set time duration for one to start and complete an activity.

32. The dispenser of claim 31 wherein the act involves cleansing one's hands.

33. A dispenser for providing material stored therein following activation of the dispenser, the dispenser comprising:
a reservoir containing one or more liquid or semi-liquid materials;
a dispensing head that is operatively coupled to the reservoir, the dispensing head comprising a button; and
an electrical circuit located within the dispensing head, the electrical circuit comprising a speaker, the electrical circuit configured to provide a message through the speaker upon activation of the button.

34. The dispenser of claim 33 wherein the one or more liquid or semi-liquid materials comprise liquid soap.

35. The dispenser of claim 33 wherein the message comprises one or more of directions, instructions, and promotional information.

36. The dispenser of claim 33 wherein the dispensing head further comprises a base, wherein the base includes a chamber, each of the base and the chamber including a mechanism adapted to shed water from inside the dispensing head to outside the dispensing head.

37. The dispenser of claim 33, wherein the dispensing head further comprises a base, wherein the base includes a vertically extending chamber, the chamber located below and in vertical alignment with the button, and wherein the electrical circuit comprises a plurality of electrical components, two or more of the electrical components being vertically stacked and extending from the chamber toward the button, a highest stacked electrical component contacting the button.

38. The dispenser of claim 33, wherein the dispensing head further comprises a cover, wherein the cover is positioned over the button, wherein the cover includes an opening receiving the button, wherein the button has a plurality of holes there through, the holes enabling the button to be a sound port for the speaker following activation of the button, and the cover being formed of an elastomeric material, whereby the cover and the button combine to form a speaker grill and housing that accentuate the sound produced by the speaker.
